(19) United States
(12) Patent Application Publication
(10) Pub. No.: US 2022/0005247 A1
(43) Pub. Date: Jan. 6, 2022

(54) APPARATUS FOR GENERATING COMPUTER READABLE INSTRUCTIONS

(71) Applicant: Hella GmbH & Co. KGaA, Lippstadt (DE)

(72) Inventors: Sarah Knoop, Salzkotten (DE); Andre Schellbach, Lippstadt (DE); Jeremias Spiegel, Lippstadt (DE)

(21) Appl. No.: 17/294,591

(22) PCT Filed: Nov. 30, 2018
(86) PCT No.: PCT/EP2018/083162

§ 371 Date: May 17, 2021

(51) Int. Cl. G06T 13/00; G06K 9/20; G06F 3/0484

(52) U.S. Cl. CPC G06T 13/00; G06F 3/04845; G06K 9/2027

(57) ABSTRACT

An apparatus is provided for generating first computer-readable instructions and second computer-readable instructions. The second computer-readable instructions are permanently stored on a memory means. The second computer-readable instructions are adapted to cause a processing means to display a virtual object on a display means. The virtual object comprises a plurality of illumination sources, each of which is capable of being displayed in an on-state and an off-state. The processing means also receives animation data via an input means, which animation data comprises information about an order in which the illumination sources are to be displayed in the on-state and off-state. The processing means also automatically generates the first computer-readable instructions using the information from the animation data. The first computer-readable instructions are adapted to cause a controller to switch light sources on and off using the information from the animation data in a real object having the light sources. The number and arrangement of the light sources correspond approximately to the number and arrangement of the illumination sources.

### CROSS REFERENCE

This application claims priority to PCT Application No. PCT/EP2018/083162, filed Nov. 30, 2018, the entirety of which is hereby incorporated by reference.

### FIELD OF THE INVENTION

This invention concerns an apparatus for generating computer-readable instructions.

### BACKGROUND

Animations of lighting devices are becoming increasingly important in the development of motor vehicles. For example, headlights, indicators, brake lights and other lighting devices can be controlled in such a way that certain animations are displayed, for example when the vehicle is unlocked or locked. Even during normal vehicle operation, a turn signal or a brake light with a specific animation may light up.

It is known that computer-readable instructions for such animations are stored in a memory of a controller for the lighting device so that they can be executed if necessary. However, the storage space is limited so that only a limited number of animations can be stored.

In the state of the art, the animations are first created using a computer with a virtual object. Animations are created by describing the state of the lighting device at a discrete step in time. The lighting device comprises several light sources. The state of the lighting device at a discrete step in time is described by a vector containing an illumination value for each of the light sources. The illumination value describes the brightness of the corresponding light source. If the user is satisfied with the animations, the computer-readable instructions for a controller of the corresponding lighting device of the motor vehicle are generated. The lighting device comprises several light sources. The instructions define a time sequence in which the light sources are switched on and off.

### SUMMARY OF THE INVENTION

It is an object of the present invention to create an apparatus with which computer-readable instructions can be generated more easily. In addition, a system with such an apparatus and a method for simpler generation of computer-readable instructions shall be created.

The apparatus comprises a memory means, a processing means, an input means and a display means. In the context of this description, a memory means is understood in particular as a computer-readable memory means. Data can be permanently stored digitally in the memory means. Permanent storage means in particular that the data remain stored even if the storage medium is de-energized for several minutes. For the purposes of this description, processing means shall mean in particular a means adapted to process computer-readable instructions. For example, it could be a digital processor. In the context of this description, an input means is a means by which inputs can be made on a computer. A computer mouse and/or keyboard, for example, can be part of the input means. In the context of this description, a display means is understood to be a means which is adapted to visually display digital data. For example, it could comprise a computer monitor.

Second computer-readable instructions are permanently stored on the memory means. The second computer-readable instructions are adapted cause the processing means to display a virtual object on the display means. The virtual object comprises several illumination sources. For example, the virtual object may be a virtual lighting device of a motor vehicle, such as a headlamp or indicator. The illumination sources can each be displayed on the display means in a switched-on and a switched-off state. In the switched-on state, the brightness of the illumination sources ca be varied. It is possible that the processing means is also caused by the second computer-readable instructions to vary the brightness of the illumination sources. It is also possible that the processing means is caused by the second computer-readable instructions to switch the illumination sources to certain colors.

The processing means is also adapted to receive animation data via the input means. The animation data includes information about an order or a sequence in which the illumination sources are to be displayed when switched on and off. If the brightness of the illumination sources can be varied, the animation data may also comprise information about the brightness of the illumination sources. If the color of the illumination sources can be varied, the animation data may also comprise information about the color of the illumination sources. Thus, by means of different switching orders of the illumination sources, animations can be displayed on the virtual object.

The second computer-readable instructions are also adapted to cause the processing means to automatically generate the first computer-readable instructions using the information from the animation data. Automatic generation means in particular that the first computer-readable instructions are generated automatically by the processing means without the user having to input these instructions via the input means. The information from the animation data is sufficient for the processing means to generate the first computer-readable instructions. The user does not need to input any further information.

The first computer-readable instructions are adapted to cause a controller to switch light sources of a real object on and off using the information from the animation data. The number and arrangement of the light sources correspond approximately to the number and arrangement of the illumination sources of the virtual object. In the context of this description, the term “approximate” is understood in particular to mean that a deviation in the number and/or arrangement is only possible to such an extent that an overall impression is retained. In particular, it is also possible that the number and arrangement of the light sources correspond exactly to the number and arrangement of the illumination sources.

It is possible that the light sources' brightness and/or color can be varied, when the light sources are switched on. If this is the case, the first computer-readable instructions may be adapted to cause the controller to control the light sources' brightness and/or color.

The real object can in particular correspond to the virtual object. This means that it looks the same from the outside. In particular, it is possible that the real object is a lighting device of a motor vehicle, such as a headlamp, indicator or brake light.

By automatically generating the first computer-readable instructions using the information from the animation data, the first computer-readable instructions can contain information about an order or a sequence in which the light sources are to be switched on and off and if their brightness is to be changed. Since the first computer-readable instructions are generated automatically, their generation is much easier than when a user has to input the instructions manually.

According to an embodiment of the invention, the processing means may be adapted to receive object information and to use the object information for displaying the virtual object on the display means. The object information can, for example, be part of data of a CAD program, where CAD stands for “Computer Aided Design”. The reception of the object information can be triggered by the input means.

According to an embodiment of the invention, the processing means may be adapted to determine the number and arrangement of the illumination sources from the object information. If the virtual object corresponds to a real object, the illumination source can look like light-emitting diodes. The workload is reduced by the automatic determination of the number and arrangement of the illumination sources. A user does not have to manually define the number and arrangement of illumination sources for the virtual object.

According to an embodiment of the invention, the information in the animation data can include information about a movement of an animation object in at least one spatial dimension in a virtual coordinate system. It should be noted that the virtual coordinate system does not necessarily have to be displayed on the display means. It is mainly used to define the movement of the animation object. The use of information about the movement of the animation object is advantageous in order to reduce the amount of memory required, in particular for storing the first computer-readable instructions. For example, an animation can be described by a uniform, accelerated and/or decelerated movement of the animation object with relatively little data. The illumination sources or light sources that lie within the animation object are switched on. Additionally, their brightness may be varied based on the animation data. The illumination sources or light sources that lie outside the animation object are switched off. More memory is needed to describe the same animation with individual on and off instructions for each individual illumination source or light source. In a very simple case, the animation object may for example comprise a geometrical object like a rectangle, a triangle or a circle. In a more complicated case, the animation object may comprise several geometrical objects. It is also possible, that the animation object comprises one or more images and/or videos. It is even possible that the animation object comprises information about one or several color(s) of the animation object.

The animation data may also comprise information pre-defined pixel data, an animation of pre-defined pixel data and/or a live pixel data stream. In these cases, the animation displayed by the illumination sources and/or light sources can contain these data. The live pixel data stream may for example comprise video data recorded at the same time as the light sources are switched on and off.

According to an embodiment of the invention, the processing means may be adapted to display the movement of the animation object on the display means by switching the illumination sources to the switched-on and to the switched-off state respectively. Additionally, their brightness and/or color may be varied. In this way it is possible to show a user directly how the animation looks like. The user can then decide whether he wants to implement this animation on a real object. If an implementation is to take place, the first computer-readable instructions are automatically generated.

According to an embodiment of the invention, the apparatus may comprise a central computer and several peripheral computers. The central computer is connected to the peripheral computers via a network connection. The memory means and the processing means are components of the central computer. The input means and the display means are components of one of the peripheral computers. This embodiment is advantageous because the second computer-readable instructions do not have to be stored on each of the peripheral computers. If the second computer-readable instructions are to be changed, this can be done on the central computer. It is not necessary to make changes to each of the peripheral computers in order to make the changed second computer-readable instructions available to as many users as possible.

According to an embodiment of the invention, the real object can be part of a motor vehicle. Also, in this embodiment, the virtual object and the real object can correspond to each other. For example, the real object may be a lighting device of a motor vehicle. The virtual object can represent this lighting device virtually. In automotive engineering, animations are particularly frequently used on lighting devices. At the same time, the storage space available in the controllers of the lighting devices is very limited. Therefore, the use of the apparatus to generate computer readable instructions in relation to a lighting device of a motor vehicle is particularly advantageous.

The system referred to in claim 8 comprises an apparatus according to an embodiment of the invention, the controller and the real object.

According to an embodiment of the invention, the processing means may be adapted to transmit the first computer-readable instructions to the controller. The controller may be adapted to permanently store and execute the first computer-readable instructions. When executing the first computer-readable instructions, the controller is caused to switch the light sources of the real object on and off using the information from the animation data. Additionally, the controller may vary their brightness and/or color. The number and arrangement of the light sources can approximately correspond to the number and arrangement of the illumination sources. In particular, it is also possible that the number and arrangement of the light sources correspond exactly to the number and arrangement of the illumination sources.

According to the method of claim 10, a virtual object is displayed on a display means. The virtual object comprises several illumination sources, each of which can be displayed in a switched-on and a switched-off state. It is also possible that the illumination sources' brightness and/or color can be varied. Animation data, for example triggered by an input means, is received. The animation data includes information about an order or a sequence in which the illumination sources are to be displayed when switched on and off. Optionally, the animation data can also comprise information about the illumination sources' brightness and/or color. For example, the information in the animation data can include information about the motion of a animation object in at least one spatial dimension in a virtual coordinate system.

First computer-readable instructions are then generated automatically using the animation data. The first computer-readable instructions can also include information about the movement of the animation object. The first computer-readable instructions are adapted to cause a controller to switch light sources on and off in a real object with the light sources, wherein the controller uses the information from the animation data. Optionally, the first computer-readable instructions are adapted to case the controller to vary the light sources' brightness and/or color. The number and arrangement of the light sources can approximately correspond to the number and arrangement of the illumination sources. In particular, it is also possible that the number and arrangement of the light sources correspond exactly to the number and arrangement of the illumination sources.

The controller may, for example, be a controller for a lighting device of a motor vehicle. The real object can be, for example, the lighting device. The virtual object can be a virtual representation of this lighting device.

Embodiments of the method may also have features disclosed in this description in relation to the apparatus or the system.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows a schematic flowchart of a method according to an embodiment of the invention.

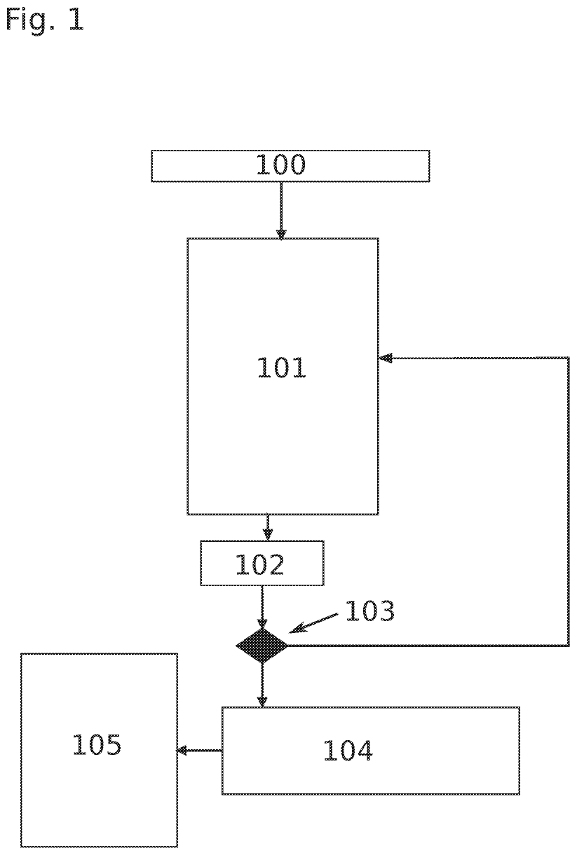

FIG. 2 shows a schematic representation of an apparatus according to an embodiment of the invention.

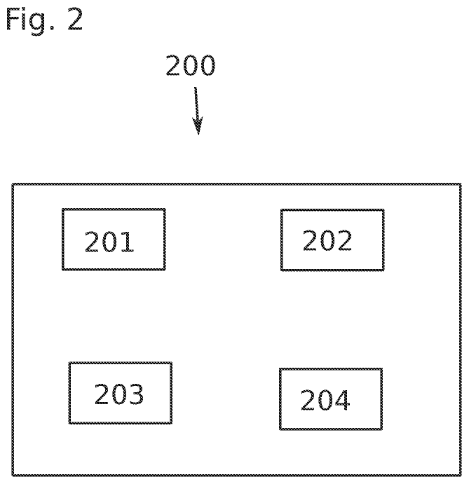

### DETAILED DESCRIPTION OF THE DRAWINGS

The method begins in step 100 with the creation of object information that is used to display a virtual object on a display means in step 101. The virtual object may, for example, be a virtual lighting device of a motor vehicle, such as a headlamp, brake light or indicator. The object information can include CAD data in particular. The virtual object includes illumination sources. In step 101, a user can define animation data that includes information about an order or a sequence in which the illumination sources are to be displayed when switched on and off. The animation data may also comprise information about the illumination sources' brightness and/or color. The animation is displayed by the virtual object by switching the illumination sources on and off in a certain order and, optionally, by varying the illumination sources' brightness and/or color.

The animation can, for example, be defined by the movement of an animation object in a virtual coordinate system. It can, for example, comprise a circle, a rectangle, a square, a triangle, which is moved in at least one dimension. The virtual coordinate system lies above, within or below the virtual object and the illumination sources within the virtual object are switched on. This is a very simple way to create an animation. In addition, less storage space is required because the movement of the animation object can be described with relatively little data and there is no need to store individual instructions for each individual illumination source.

Once the user has created an animation that he wants to transfer to a real object, a real sample can be created in step 102. This may be, for example, a sample of a real lighting device of a motor vehicle. The sample looks optically like the virtual object. In particular, the sample has the same number and arrangement of light sources as the number and arrangement of illumination sources of the virtual object. The animation can be viewed on the sample in reality by the user.

In step 103, the user then decides whether to change the animation. If so, step 101 is executed again. If no changes are to be made, first computer-readable instructions are automatically generated in step 104. The first computer-readable instructions are adapted to cause a controller of a lighting device of a motor vehicle to switch the light sources of the lighting device on and off using the information from the animation data. Optionally, the first computer-readable instructions may also be adapted to cause the controller to vary the light sources' brightness and/or color. When the first computer-readable instructions are executed by the controller, the animation is displayed by the lighting device. In this case, the lighting device is a real object that corresponds to the virtual object. The number and arrangement of the light sources of the real lighting device correspond to the number and arrangement of the illumination sources of the virtual lighting device.

In step 105, the first computer-readable instructions are then transmitted to the controller of the lighting device and permanently stored in the controller. The lighting device is then adapted to display the animation by switching the light sources on and off and, optionally, varying their brightness and/or color. It is particularly advantageous that the information from the animation data obtained in the first computer-readable instructions includes the movement of the animation object in the virtual coordinate system. As already mentioned, this requires very little memory space to store various animations. Storage space is usually very limited in controllers of automotive lighting devices.

The apparatus 200 comprises memory means 201, processing means 202, input means 203 and display means 204. The memory means 201 is adapted to permanently store second computer-readable instructions. Processing means 202 is adapted to execute these second computer-readable instructions. When these second computer-readable instructions are executed, the processing means 202 is caused to execute a method according to an embodiment of the invention. For example, processing means 202 may comprise a processor of a computer.

Input means 203 may include, for example, a keyboard and/or a computer mouse. For example, the display means 204 may include a monitor. On the display means 204 the virtual object can be displayed to the user. With the input means 203 the user can generate the animation data and trigger the automatic generation of the first computer-readable instructions.

### LIST OF REFERENCE NUMERALS

100 Creation of object information
101 Displaying a virtual object
102 Making a sample
103 Decision as to whether changes are to be made
104 Generation of first computer-readable instructions
105 Transmission of first computer-readable instructions to a controller
200 Apparatus
201 Memory means
202 Processing means
203 Input means
204 Display means

1. An apparatus for generating first computer-readable instructions, the apparatus comprising:
an electronic memory;
a processor;
an input device; and
a display device;
wherein second computer-readable instructions are permanently stored on the electronic memory, and wherein the second computer-readable instructions, upon execution by the processor, cause the processor to effectuate the following steps:
display a virtual object on said display device, said virtual object comprising a plurality of illumination sources, each of which is capable of being displayed in an on-state and an off-state;
receive animation data via the input device, the animation data comprising information about an order in which the illumination sources are to be displayed in the on-state and off-state,
automatically generate the first computer-readable instructions using said information from said animation data, said first computer-readable instructions being adapted to cause a controller to switch light sources of a real object on and off using said information from said animation data, the number and arrangement of said light sources corresponding to the number and arrangement of said illumination sources.

2. The apparatus according to claim 1, wherein the processor is adapted to receive object information and to use the object information for displaying the virtual object on the display device, the receipt of the object information being triggered by the input device.

3. The apparatus according to claim 2, wherein the processor determines the number and arrangement of the illumination sources from the object information.

4. The apparatus according to claim 1, wherein the information in the animation data comprises information about a movement of an animation object in at least one spatial dimension in a virtual coordinate system.

5. The apparatus according to claim 1, wherein the processor causes display of the movement of the animation object on the display device by switching the illumination sources respectively to the on-state and to the off-state.

6. The apparatus according to claim 1, further comprising:
a central computer and a plurality of peripheral computers,
wherein the central computer is connected to the peripheral computers via a network connection,
wherein the electronic memory and the processor are components of the central computer, and wherein the input device and the display device are components of one of the peripheral computers.

7. The apparatus according to claim 1, wherein the real object is part of a motor vehicle.

8. A system comprising:
an apparatus according to claim 1,
a controller and
a real object.

9. The system according to claim 8, wherein the processor is adapted to transmit the first computer-readable instructions to the controller, the controller being adapted to permanently store and execute the first computer-readable instructions, wherein the first computer-readable instructions are adapted to cause the controller to switch the light sources of the real object on and off using the information from the animation data, the number and arrangement of the light sources corresponding to the number and arrangement of the illumination sources.

10. A method of generating first computer-readable instructions comprising the steps of:
displaying a virtual object on a display device, the virtual object comprising a plurality of illumination sources each capable of being displayed in an on-state and an off-state;
receiving animation data, the animation data comprising information about an order in which the illumination sources are to be displayed in the switched-on and switched-off state; and
automatically generating the first computer-readable instructions using the animation data, the first computer-readable instructions causing a controller to turn light sources on and off using the information from the animation data in a real object having the light sources, the number and arrangement of the light sources corresponding to the number and arrangement of the illumination sources.
